(19) United States
(12) Patent Application Publication
(10) Pub. No.: US 2020/0094518 A1
(43) Pub. Date: Mar. 26, 2020

(54) THIN, HIGH-STIFFNESS LAMINATES, PORTABLE ELECTRONIC DEVICE HOUSINGS INCLUDING THE SAME, AND METHODS FOR MAKING SUCH LAMINATES AND PORTABLE ELECTRONIC DEVICE HOUSINGS

(71) Applicant: SABIC Global Technologies B.V., Bergen op Zoom (NL)

(72) Inventors: Theofanis THEOFANOUS, Geleen (NL); Nikhil VERGHESE, Geleen (NL); Syed Muhammad KASHIF, Geleen (NL)

(21) Appl. No.: 16/495,556

(22) PCT Filed: Mar. 19, 2018
(86) PCT No.: PCT/IB2018/051834

§ 371 Date: Sep. 19, 2019

Related U.S. Application Data
(60) Provisional application No. 62/473,480, filed on Mar. 19, 2017.

(51) Int. Cl. B32B 5/26; B32B 5/02; B32B 5/12; G06F 1/16

(52) U.S. Cl. CPC B32B 5/26; B32B 5/024; B32B 5/12; G06F 1/1616; B32B 2457/00; B32B 2260/021; B32B 2260/046; B32B 2307/546; B32B 2262/106

(57) ABSTRACT

The present disclosure includes thin, high-stiffness laminates, portable electronic device housings including the same, and methods for making such laminates and portable electronic device housings. Some laminates include two or more laminae, each having fibers dispersed within a matrix material, wherein the laminate has a width, a length that is perpendicular to the width, the length being between approximately 1.25 and approximately 1.80 times the width, a thickness that is perpendicular to each of the width and the length, the thickness being between approximately 1.0 mm and approximately 1.5 mm, and a first flexural rigidity along the width and a second flexural rigidity along the length, the second flexural rigidity being 10 to 30 times the first flexural rigidity.

### CROSS-REFERENCE TO RELATED APPLICATIONS

This application claims the benefit of priority of U.S. Provisional Patent Application No. 62/473,480 filed Mar. 19, 2017. The entire contents of each of the above-referenced disclosures are specifically incorporated herein by reference without disclaimer.

### BACKGROUND

### 1. Field of Invention

The present invention relates generally to fiber-reinforced composites, and more specifically, to thin, high-stiffness laminates that may be suitable for use in a variety of applications, including portable electronic device (e.g., laptop) housings.

### 2. Description of Related Art

Fiber-reinforced composites can be used to form structures having advantageous structural characteristics, such as high stiffnesses and high strengths, as well as relatively low weights, when compared to similar structures formed from conventional materials. As a result, fiber-reinforced composites are used in a variety of applications across a wide range of industries, including the automotive, aerospace, and consumer electronics industries.

In many applications, the use of fiber-reinforced composites to increase the stiffness of a structure can be limited by the size, weight, and/or cost requirements of the structure. For example, a typical portable electronic device includes a housing for receiving components (e.g., a screen, processor, board, user-input device, other component, and/or the like) of the device that needs to be sufficiently stiff to protect the components against damage, while being relatively small (e.g., thin-walled), light, and inexpensive. Fiber-reinforced composites for use in such applications that are sufficiently thin may not be as stiff as desired, and those that are as stiff as desired may not be sufficiently thin.

### SUMMARY

Some embodiments of the present laminates can address these needs by having a relatively small thickness (e.g., less than approximately 2.00, 1.75, 1.50, or 1.25 millimeters (mm)) as well as a relatively high resistance to deflection; for example, when the edges of the laminate are simply supported and a force of 100 newtons (N) is applied to the center of and perpendicularly to the laminate, the center of the laminate may deflect by less than approximately 4.0, 3.9, 3.8, 3.7, 3.6, or 3.5 mm. In some laminates, such advantageous structural characteristics can be provided by the laminate having a width and a length that is larger than (e.g., approximately 1.5 times larger than) the width, a first flexural rigidity along the width, and a second flexural rigidity along the length that is 10 to 30 times or 14 to 26 times the first flexural rigidity. In some laminates, such flexural rigidities can be achieved using a layup of two or more unidirectional first laminae, each having fibers that are aligned with the width, and one or more unidirectional second laminae disposed between two of the first laminae, each having fibers that are aligned with the length.

The term “coupled” is defined as connected, although not necessarily directly, and not necessarily mechanically; two items that are “coupled” may be unitary with each other. The terms “a” and “an” are defined as one or more unless this disclosure explicitly requires otherwise. The term “substantially” is defined as largely but not necessarily wholly what is specified (and includes what is specified; e.g., substantially 90 degrees includes 90 degrees and substantially parallel includes parallel), as understood by a person of ordinary skill in the art. In any disclosed embodiment, the terms “substantially” and “approximately” may be substituted with “within [a percentage] of” what is specified, where the percentage includes 0.1, 1, 5, and 10 percent.

The phrase “and/or” means and or or. To illustrate, A, B, and/or C includes: A alone, B alone, C alone, a combination of A and B, a combination of A and C, a combination of B and C, or a combination of A, B, and C. In other words, “and/or” operates as an inclusive or.

Further, a device or system that is configured in a certain way is configured in at least that way, but it can also be configured in other ways than those specifically described.

The terms “comprise” (and any form of comprise, such as “comprises” and “comprising”), “have” (and any form of have, such as “has” and “having”), and “include” (and any form of include, such as “includes” and “including”) are open-ended linking verbs. As a result, an apparatus that “comprises,” “has,” or “includes” one or more elements possesses those one or more elements, but is not limited to possessing only those one or more elements. Likewise, a method that “comprises,” “has,” or “includes” one or more steps possesses those one or more steps, but is not limited to possessing only those one or more steps.

Any embodiment of any of the apparatuses, systems, and methods can consist of or consist essentially of—rather than comprise/have/include—any of the described steps, elements, and/or features. Thus, in any of the claims, the term “consisting of” or “consisting essentially of” can be substituted for any of the open-ended linking verbs recited above, in order to change the scope of a given claim from what it would otherwise be using the open-ended linking verb.

The feature or features of one embodiment may be applied to other embodiments, even though not described or illustrated, unless expressly prohibited by this disclosure or the nature of the embodiments.

Some details associated with the embodiments are described above and others are described below.

### BRIEF DESCRIPTION OF THE DRAWINGS

The following drawings illustrate by way of example and not limitation. For the sake of brevity and clarity, every feature of a given structure is not always labeled in every figure in which that structure appears. Identical reference numbers do not necessarily indicate an identical structure. Rather, the same reference number may be used to indicate a similar feature or a feature with similar functionality, as may non-identical reference numbers.

FIG. 1A is a schematic top view of one embodiment of the present laminates.

FIG. 1B is a schematic cross-sectional side view of the laminate of FIG. 1A, taken along line 1B-1B of FIG. 1A.

FIG. 1C is a schematic cross-sectional end view of the laminate of FIG. 1A, taken along line 1C-1C of FIG. 1A.

FIG. 1D is a schematic exploded view of the laminate of FIG. 1A.

FIGS. 2A and 2B are schematic top views of laminae, each of which may be suitable for use in some of the present laminates.

FIG. 3 is a schematic top view of a lamina formed from sections of unidirectional fiber tape, which may be suitable for use in some of the present laminates.

FIG. 4 is a schematic perspective view of one embodiment of the present laptop housings that includes one or more of the present laminates.

FIG. 5A is a schematic bottom view of the A cover of the laptop housing of FIG. 4.

FIG. 5B is a schematic cross-sectional end view of the A cover of FIG. 5A, taken along line 5B-5B of FIG. 5A.

FIG. 6 depicts a method for measuring the deflection of a laminate in response to a load.

FIG. 7 is a graph showing deflection vs 90-degree ply thickness for laminates of the present disclosure.

FIG. 8 is a graph showing actual and predicted deflections for three laminates of the present disclosure.

### DETAILED DESCRIPTION

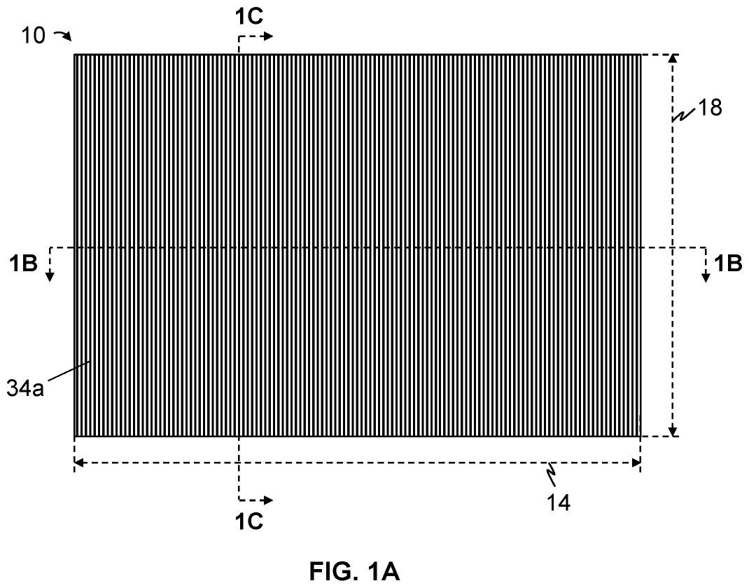

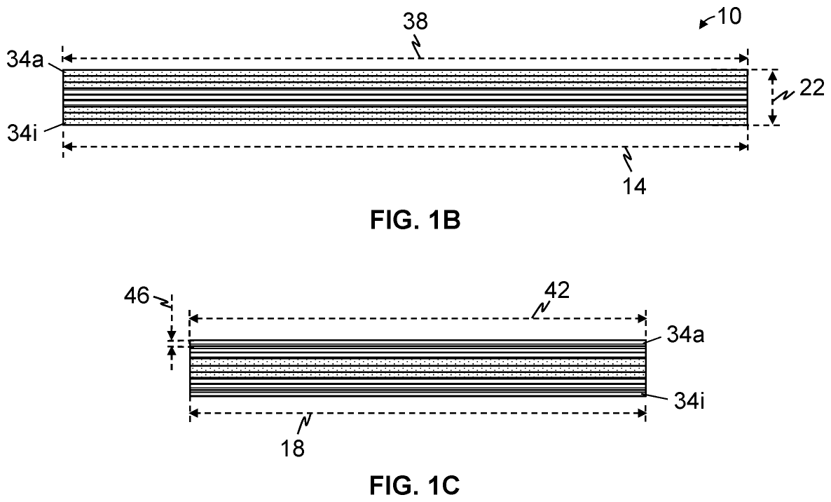

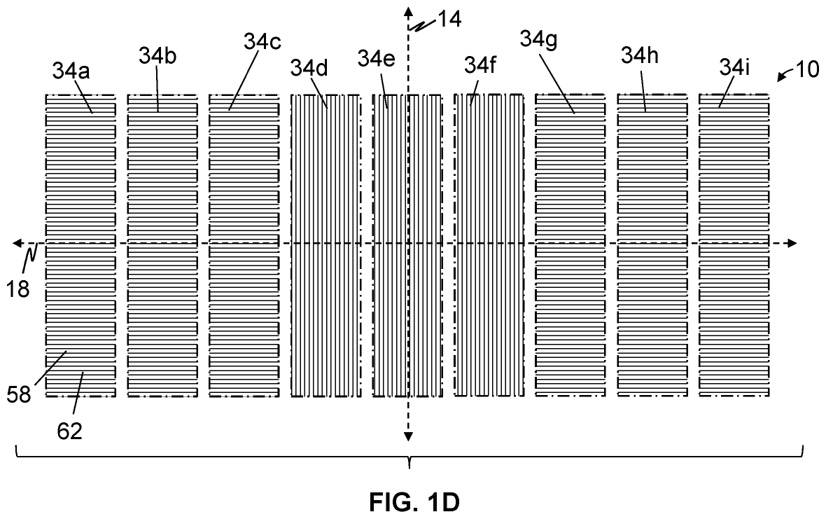

The present laminates can be used in a variety of applications in which a thin, high-stiffness laminate is desirable, including, for example, in the production of vehicle components, aircraft components, consumer electronics components, and/or the like. Provided by way of example, FIGS. 1A-1D depict one embodiment 10 of the present laminates that is configured for use in a portable electronic device housing. More particularly, laminate 10 is for use in an A cover (e.g., 134) of a laptop housing (e.g., 110) (described in more detail below); however, other embodiments of the present laminates can be used in any suitable portable electronic device housing, such as, for example, a mobile phone, digital assistant, pager, tablet, media player, handheld gaming device, camera, watch, navigation device, and/or the like housing.

The present laminates can be dimensioned and shaped according to their respective applications. For example, laminate 10 includes a length 14 and a width 18 that is perpendicular to and smaller than the length. Length 14 and width 18 are each a distance measured between outer edges of the laminate along a straight line; the length can be, but need not be, the largest such distance. Length 14 can be greater than or substantially equal to any one of, or between any two of: 25, 26, 27, 28, 29, 30, 31, 32, 33, 34, or 35 centimeters (cm) (e.g., approximately 31 cm) and/or greater than or substantially equal to any one of, or between any two of: 1.25, 1.30, 1.35, 1.40, 1.45, 1.50, 1.55, 1.60, 1.65, 1.70, 1.75, or 1.80 times width 18. Width 18 can be greater than or substantially equal to any one of, or between any two of: 14, 15, 16, 17, 18, 19, 20, 21, 22, 23, 24, 25, 26, 27, 28, 29, or 30 cm (e.g., approximately 21 cm). Laminate 10 is rectangular; however, other embodiments of the present laminates can be triangular, square, or otherwise polygonal (whether having sharp and/or rounded corners), circular, elliptical, or otherwise rounded, or can have an irregular shape. Some embodiments of the present laminates can include one or more openings, notches, and/or the like, which can facilitate incorporation of the laminate into a structure. To illustrate, in embodiments of the present laminates for use in a housing of a portable electronic device, such opening(s), notch(es), and/or the like can allow for mounting and/or operation of other component(s) (e.g., button(s), other user-input device(s), camera(s), and/or the like) of the portable electronic device.

Laminate 10 has a thickness 22 (FIG. 1B) that is measured perpendicularly to both length 14 and width 18. Thickness 22 can be less than or substantially equal to any one of, or between any two of: 0.5, 0.6, 0.7, 0.8, 0.9, 1.0, 1.1, 1.2, 1.3, 1.4, 1.5, 1.6, 1.7, 1.8, 1.9, or 2.0 mm. For laminate 10, thickness 22 is substantially uniform throughout the laminate; however, other embodiments of the present laminates can have a varying thickness. As described below, embodiments of the present laminates, at least via selection of their respective laminae, can have relatively high resistances to deflection at such relatively low thicknesses.

The present laminates are laminates in that each includes two or more laminae (e.g., 34a-34i) that have been consolidated (e.g., using heat and/or pressure). Laminate 10 includes 9 laminae, 34a-34i; however, other embodiments of the present laminates can include any suitable number of laminae (e.g., 2, 3, 4, 5, 6, 7, 8, 9, 10, 11, 12, 13, 14, 15, or more laminae).

Each of laminae 34a-34i has a length 38 and a width 42 that is perpendicular to and smaller than the length, where the length and the width are each a distance between outer edges of the lamina measured along a straight line (labeled for lamina 34a in FIG. 1C). Length 38 can be, but need not be, the largest such distance. Each of the laminae has a shape and dimensions that correspond to the shape and dimensions of laminate 10. To illustrate, for each of the laminae, length 38 is aligned with and substantially equal to length 14 of laminate 10, and width 42 is aligned with and substantially equal to width 18 of the laminate. As used herein, “aligned with” means within 10 degrees of parallel to. To further illustrate, the largest face of each of the laminae has a surface area that is substantially equal to a surface area of the largest face of laminate 10. To yet further illustrate, each of the laminae is rectangular. In other embodiments, one or more laminae of a laminate can have a shape and/or dimensions that differ from the shape and/or dimensions of the laminate; such lamina(e) can, for example, be used to add stiffness and strength to a portion of the laminate that is smaller than the entirety of the laminate.

In laminate 10, each of laminae 34a-34i has a pre-consolidation thickness 46 that is between approximately 0.13 mm and approximately 0.16 mm (labeled for lamina 34a in FIG. 1C). In other embodiments of the present laminates, laminae can each include any suitable thickness, such as, for example, a pre-consolidation thickness (e.g., 46) that is greater than or substantially equal to any one of, or between any two of: 0.10, 0.11, 0.12, 0.13, 0.14, 0.15, 0.16, 0.17, 0.18, 0.19, 0.20, 0.21, 0.22, 0.23, 0.24, 0.25, 0.30, 0.35, 0.40, 0.45, or 0.50 mm.

Each of laminae 34a-34i includes fibers 58 dispersed within a matrix material 62. Fibers (e.g., 58) of the present laminates (e.g., 10) can include any suitable fibers, such as, for example, carbon fibers, glass fibers, aramid fibers, polyethylene fibers, polyester fibers, polyamide fibers, ceramic fibers, basalt fibers, steel fibers, and/or the like. Matrix materials (e.g., 62) of the present laminates (e.g., 10) can include thermoplastic and/or thermoset materials. For example, a suitable thermoplastic material can include polyethylene terephthalate, polycarbonate (PC), polybutylene terephthalate (PBT), poly(1,4-cyclohexylidene cyclohexane-1,4-dicarboxylate) (PCCD), glycol-modified polycyclohexyl terephthalate (PCTG), poly(phenylene oxide) (PPO), polypropylene (PP), polyethylene (PE), polyvinyl chloride (PVC), polystyrene (PS), polymethyl methacrylate (PMMA), polyethyleneimine or polyetherimide (PEI) or a derivative thereof, a thermoplastic elastomer (TPE), a terephthalic acid (TPA) elastomer, poly(cyclohexanedimethylene terephthalate) (PCT), polyethylene naphthalate (PEN), a polyamide (PA), polystyrene sulfonate (PSS), polyether ether ketone (PEEK), polyether ketone ketone (PEKK), acrylonitrile butyldiene styrene (ABS), polyphenylene sulfide (PPS), a copolymer thereof, or a blend thereof. For further example, a suitable thermoset material can include an unsaturated polyester resin, a polyurethane, bakelite, duroplast, urea-formaldehyde, diallyl-phthalate, epoxy resin, an epoxy vinylester, a polyimide, a cyanate ester of a polycyanurate, dicyclopentadiene, a phenolic, a benzoxazine, a co-polymer thereof, or a blend thereof. Laminae (e.g., 34a-34i) including fibers (e.g., 58) can have a pre-consolidation fiber volume fraction (Vf) that is greater than or substantially equal to any one of, or between any two of: 40, 45, 50, 55, 60, 65, 70, 75, 80, 85, or 90%. In some embodiments of the present laminates, one or more laminae may not include fibers (e.g., 58); such lamina(e) can, for example, comprise a sheet of a matrix material (e.g., 62).

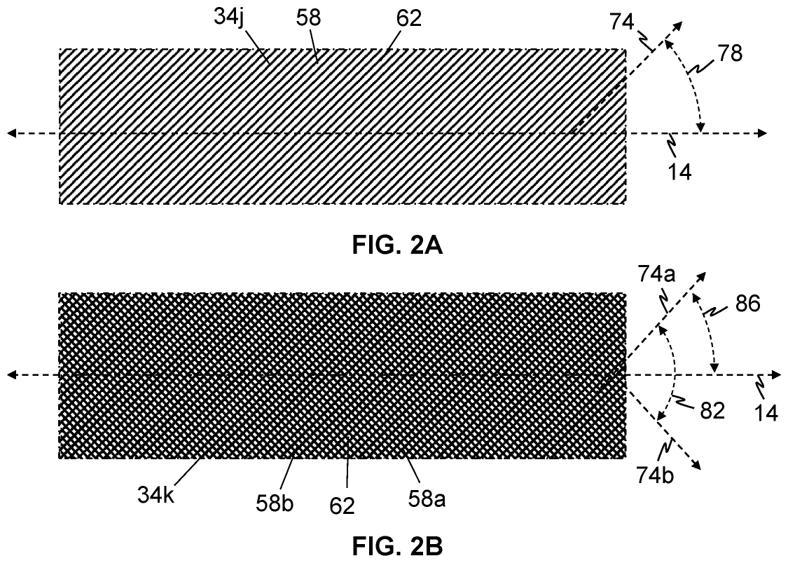

In laminate 10, each of laminae 34a-34i is a unidirectional lamina, or a lamina having fibers 58, substantially all of which are aligned in a single direction. More particularly, in each of the laminae, fibers 58 are aligned with either length 14 of laminate 10 (e.g., laminae 34d-34f, each of which may be characterized as a 0-degree unidirectional lamina) or width 18 of the laminate (e.g., laminae 34a-34c and 34g-34i, each of which may be characterized as a 90-degree unidirectional lamina). Other embodiments of the present laminates can include one or more unidirectional laminae, each having fibers that are aligned in any suitable direction. For example, and referring additionally to FIG. 2A, unidirectional lamina 34j includes fibers 58 aligned in a direction 74, where a smallest angle 78 between direction 74 and a length (e.g., 14) of a laminate including lamina 34j can be greater than or substantially equal to any one of, or between any two of: 0, 5, 10, 15, 20, 25, 30, 35, 40, 45, 50, 55, 60, 65, 70, 75, 80, 85, or 90 degrees.

Some embodiments of the present laminates can include one or more laminae, each having fibers that define a woven structure (e.g., as in a lamina having a plane, twill, satin, basket, leno, mock leno, or the like weave). For example, and referring additionally to FIG. 2B, lamina 34k includes a first set of fibers 58a aligned in a first direction 74a and a second set of fibers 58b aligned in a second direction 74b that is angularly disposed relative to the first direction, where the first set of fibers is woven with the second set of fibers. A smallest angle 82 between first direction 74a and second direction 74b can be greater than or substantially equal to any one of, or between any two of: 10, 15, 20, 25, 30, 35, 40, 45, 50, 55, 60, 65, 70, 75, 80, 85, or 90 degrees. A smallest angle 86 between first direction 74a and a length (e.g., 14) of a laminate including lamina 34k can be greater than or substantially equal to any one of, or between any two of: 0, 5, 10, 15, 20, 25, 30, 35, 40, 45, 50, 55, 60, 65, 70, 75, 80, 85, or 90 degrees.

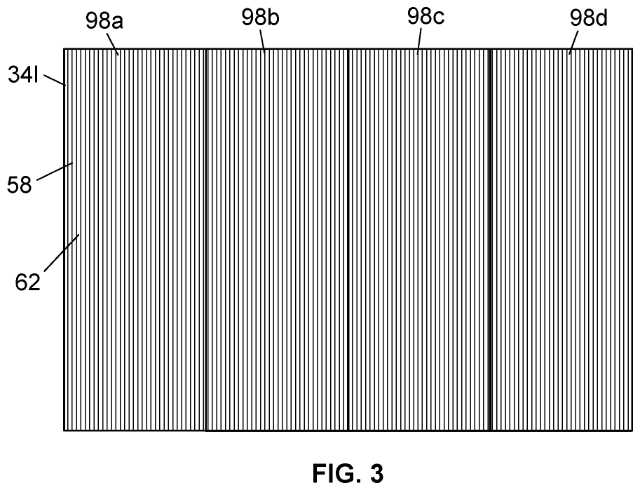

Some embodiments of the present laminates can include one or more laminae, each formed from sections of lamina material. For example, FIG. 3 depicts a unidirectional lamina 341 formed from sections (e.g., 98a-98d) of unidirectional fiber tape that have been placed adjacent to one another. To form such a lamina (e.g., 341), sections (e.g., 98a-98d) of lamina material can be placed adjacent to one another manually and/or by an automated tape laying machine.

In laminate 10, 0-degree unidirectional laminae 34d-34f and 90-degree unidirectional laminae 34a-34c and 34g-34i are stacked such that the 0-degree unidirectional laminae are in contact with one another (meaning each is in contact with at least one other) and are disposed between two of the 90-degree unidirectional laminae. More particularly, laminate 10 includes first and second substacks of 90-degree unidirectional laminae and a third substack of 0-degree unidirectional laminae, where the third substack is disposed between the first and second substacks. In laminate 10, each of the substacks comprises three laminae; however, in other embodiments, such substacks can each be replaced with a single lamina or can include 2, 3, 4, 5, 6, 7, 8, 9, or more laminae. Other embodiments of the present laminates can include any suitable laminae (e.g., including one or more of any lamina described above) stacked in any suitable configuration (e.g., balanced, symmetric, asymmetric, and/or the like).

A laminate (e.g., 10) of the present disclosure can possess a relatively high resistance to deflection while having a relatively small thickness (e.g., 22) (e.g., less than approximately 2.00, 1.75, 1.50, or 1.25 mm) at least by having any one of a certain range of ratios between its lengthwise flexural rigidity and its widthwise flexural rigidity. As lengthwise and widthwise flexural rigidities for a laminate vary with the dimensions of the laminate, so too does the desired range of ratios between the lengthwise and widthwise flexural rigidities for the laminate. For example, for a laminate (e.g., 10) having a length (e.g., 14) that is between 1.25 and 1.8 times its width (e.g., 18) (e.g., approximately 1.5 times its width), the flexural rigidity of the laminate along its length can be 10 to 30 times or 14 to 26 times the flexural rigidity of the laminate along its width. For further example, for a laminate (e.g., 10) having a length (e.g., 14) that is approximately 1.476 times its width (e.g., 18), the laminate's lengthwise flexural rigidity can be 12 to 30 times or 16 to 26 times its widthwise flexural rigidity. For yet further example, for a laminate (e.g., 10) having a length (e.g., 14) that is approximately 1.535 times its width (e.g., 18), the laminate's lengthwise flexural rigidity can be 10 to 18 times or 14 to 22 times its widthwise flexural rigidity. Desired lengthwise and widthwise flexural rigidities can be achieved for a laminate (e.g., 10) at least by selecting its dimensions (e.g., length 14, width 18, and thickness 22), its respective laminae (e.g., 34a-34i) and dimensions (e.g., lengths 38, widths 42, and thicknesses 46) thereof, and the order in which such laminae are stacked.

Not to be bound by theory, the flexural rigidity of a laminate (e.g., 10) in a given direction, i, can be expressed as:

Fᵢ=EᵢIᵢ (1)

where Eᵢ is the modulus of elasticity of the laminate in direction i, and Iᵢ is the area moment of inertia of the laminate about the axis of bending, which is perpendicular to direction i.

To illustrate, the flexural rigidity of laminate 10 along width 18 can be determined as follows. As laminae 34a-34i are 0- and 90-degree unidirectional laminae, the modulus of elasticity of laminate 10 along width 18 is a function of the moduli of elasticity of the laminae in the widthwise direction, which can be approximated using the rule of mixtures. In particular, the modulus of elasticity of each 90-degree unidirectional lamina in the widthwise direction can be expressed as:

E_{w}=E_{fiber}×V_{f}+Eₘₐₜᵣᵢₓ×(1−V_{f}) (2)

where E_{fiber} is the modulus of elasticity of the fibers of the lamina, Eₘₐₜᵣᵢₓ is the modulus of elasticity of the matrix material of the lamina, and V_{f} is the fiber volume fraction of the lamina. The modulus of elasticity of each 0-degree unidirectional lamina in the widthwise direction can be expressed as:

$${E}_{w} = {( \frac{{V}_{f}}{{E}_{fiber}} + \frac{1 - {V}_{f}}{{E}_{matirx}} )}^{- 1} \qquad ( 3 )$$

As evidenced by Eqs. (2) and (3), contributions to the stiffness of laminate 10 in the widthwise direction from the 90-degree unidirectional laminae are significantly larger than those from the 0-degree unidirectional laminae; as a result, such contributions from the 0-degree unidirectional laminae may be ignored.

Assuming a rectangular cross-section for laminate 10 along length 14 and ignoring portions of the laminate occupied by the 0-degree unidirectional laminae, the relevant area moment of inertia can be expressed as:

$${I}_{w} = \frac{l \times {t}_{tot}^{3}}{12} - \frac{l \times {t}_{0}^{3}}{12} \qquad ( 4 )$$

where l is length 14 of the laminate, tₜₒₜ is thickness 22 of the laminate, and t₀ is the collective thickness of the 0-degree unidirectional laminates.

Finally, the flexural rigidity of laminate 10 along width 18 can be expressed as:

$${F}_{w} = {E}_{w} ( \frac{l \times {t}_{tot}^{3}}{12} - \frac{l \times {t}_{0}^{3}}{12} ) \qquad ( 5 )$$

The flexural rigidity of laminate 10 along length 14 can be determined in a similar fashion. In particular, the modulus of elasticity of each 0-degree unidirectional lamina in the lengthwise direction can be expressed as:

Eₗ=E_{fiber}×V_{f}+Eₘₐₜᵣᵢₓ×(1−V_{f}) (6)

and the modulus of elasticity of each 90-degree unidirectional lamina in the lengthwise direction can be expressed as:

$${E}_{l} = {( \frac{{V}_{f}}{{E}_{fiber}} + \frac{1 - {V}_{f}}{{E}_{matirx}} )}^{- 1} \qquad ( 7 )$$

Because contributions to the stiffness of laminate 10 in the lengthwise direction from the 0-degree unidirectional laminae are significantly larger than those from the 90-degree unidirectional laminae, such contributions from the 90-degree unidirectional laminae may be ignored.

Assuming a rectangular cross-section for laminate 10 along width 18 and ignoring portions of the laminate occupied by the 90-degree unidirectional laminae, the relevant area moment of inertia can be expressed as:

$${I}_{l} = \frac{w \times {t}_{0}^{3}}{12} \qquad ( 8 )$$

where w is the width of the laminate.

Thus, the flexural rigidity of laminate 10 along length 14 can be expressed as:

$${F}_{l} = {E}_{l} ( \frac{w \times {t}_{0}^{3}}{12} ) \qquad ( 9 )$$

By dividing Eq. (5) with Eq. (9), the flexural rigidities of laminate 10 along width 18 and length 14 can be expressed as a stiffness ratio, S:

$$S = \frac{{E}_{w} \times l \times ( {t}_{tot}^{3} - {t}_{0}^{3} )}{{E}_{l} \times w \times {t}_{0}^{3}} \qquad ( 10 )$$

which can be simplified by substituting 1 with:

l=r×w (11)

where r is the aspect ratio of the laminate. After this substitution, the stiffness ratio can be expressed as:

$$S = \frac{{E}_{w} \times r \times ( {t}_{tot}^{3} - {t}_{0}^{3} )}{{E}_{l} \times {t}_{0}^{3}} \qquad ( 12 )$$

Of course, moduli of elasticity and/or flexural rigidities of the present laminates can be determined experimentally and/or using other theories. For example, the modulus of elasticity and/or flexural rigidity of a laminate and/or a lamina thereof can be approximated using a concentric cylinders model, finite element analysis, and/or the like and/or can be determined experimentally.

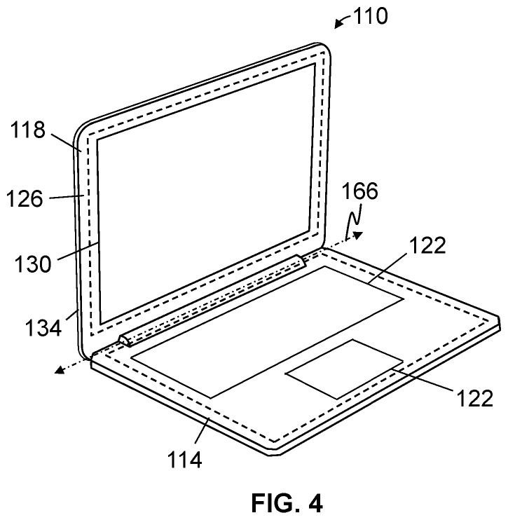

Referring additionally to FIG. 4, shown is a schematic perspective view of one embodiment 110 of the present laptop housings. Laptop housing 110 includes a base 114 and a lid 118 that can be movably (e.g., hingedly, in this embodiment) coupled to the base. Each of base 114 and lid 118 can be characterized as a thin-walled (e.g., on the order of mm) shell configured to receive laptop components. For example, laptop components receivable by base 114 can include a processor, motherboard, power supply, user-input device(s) (e.g., a keyboard, touchpad, and/or the like), cooling fan(s), and/or the like. To facilitate operation of such laptop components once they are received by base 114, the base can define one or more openings 122 in communication with its interior (e.g., to allow user access to the user-input device(s), permit airflow to and/or from the cooling fan(s), allow external device(s) to be connected to the motherboard, and/or the like). Base 114 can comprise an assembly of two or more portions (e.g., an upper portion and a lower portion), to, for example, facilitate receipt of such laptop components by the base (e.g., during assembly of a laptop including the base).

Laptop components receivable by lid 118 can include a screen, user-input device(s) (e.g., a camera, microphone, and/or the like), and/or the like. For example, lid 118 can include a frame 126 defining an opening 130, where a laptop screen can be coupled to the frame such that the screen is viewable by a user through the opening. To increase the stiffness and strength of lid 118, facilitate receipt of a laptop screen by the lid, and/or for aesthetic purposes, the lid can include an A cover 134 (described in more detail below) configured to be coupled to frame 126. A cover 134 can be coupled to frame 126 in any suitable fashion, such as, for example, via interlocking features of the A cover and the frame (e.g., such as snap-fit connection(s)), fastener(s), adhesive, welding, and/or the like. In some embodiments, an A cover (e.g., 134) of a lid (e.g., 118) can be unitary with a frame (e.g., 126) of the lid.

It is desirable for a laptop housing (e.g., 110) to be sufficiently stiff to protect components received by the laptop housing against damage as well as to be relatively small (e.g., thin-walled), light, and inexpensive. Some embodiments of the present laptop housings (e.g., 110) can achieve such advantageous characteristics by including embodiment(s) of the present laminates (e.g., 10). For example, in some of the present laptop housings (e.g., 110), laminate(s) (e.g., 10) can be disposed within, on, and/or can form at least a portion of a wall of the laptop housing (e.g., a wall of a base 114 and/or a wall of a lid 118). To illustrate, in laptop housing 110, such laminate(s) (e.g., 10) can be disposed within, on, and/or can form at least a portion of an upper wall and/or a lower wall of base 114 and/or lid 118 (generally indicated with dashed lines in FIG. 4).

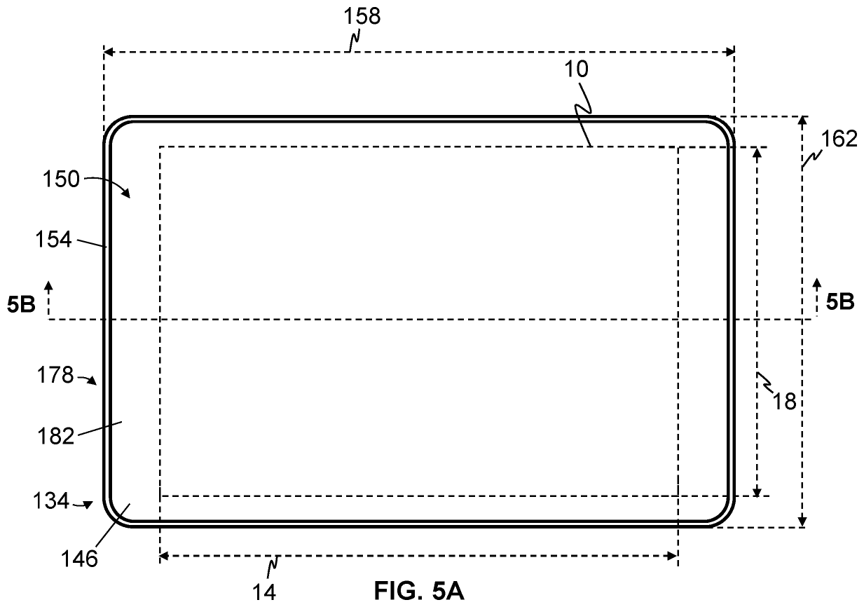

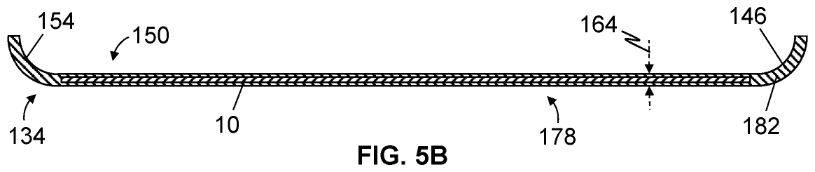

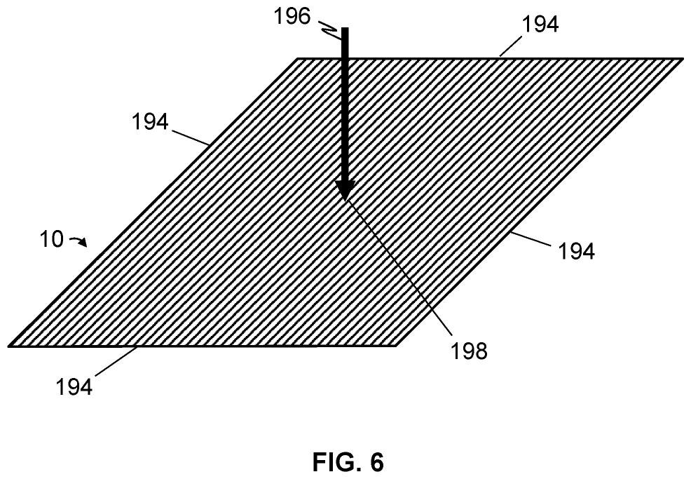

To further illustrate, and referring additionally to FIGS. 5A and 5B, shown are bottom and cross-sectional end views of A cover 134. A cover 134 includes a plate 146. Plate 146 can have a planar portion 150 and a lip 154 that extends outwardly from and surrounds at least a majority of the planar portion. Plate 146 has a length 158 and a width 162 that is perpendicular to and smaller than the length. Length 158 and width 162 are each a distance measured between outer edges of plate 146 along a straight line. More particularly, length 158 can be measured along a line that bisects plate 146, is perpendicular to the outer edges of the plate through which it extends, is aligned with an axis about which lid 118 is rotatable relative to base 114 (e.g., hinge axis 166, FIG. 4), and/or the like. In this embodiment, plate 146 is rectangular, having rounded corners (e.g., and length 158 can be measured along a line that is aligned with its longest sides); however, in other embodiments, a plate (e.g., 146) can be triangular, rectangular, square, or otherwise polygonal (whether having sharp and/or rounded corners), circular, elliptical, or otherwise rounded, or can have an irregular shape.

A cover 134 can include a composite body 178 that defines plate 146. Body 178 can be characterized as “composite” in that the body includes a plastic material 182 and a laminate (e.g., 10), where the plastic material and the laminate are combined to form a unitary structure. As one non-limiting example, composite body 178 can be formed by overmolding plastic material 182 onto the laminate; in some embodiments, the laminate can be glued, welded, and/or the like to the plastic material. Plastic material 182 can include any suitable plastic material, including any one or more of the thermoplastic and thermoset materials described above. Plastic material 182 can include dispersed elements, such as, for example, discontinuous or short fibers (e.g., of any type described above), which can account for 10 to 70% of the plastic material by weight. In some embodiments, a plastic material (e.g., 182) can include the same material as a matrix material (e.g., 62) of the laminate, which can facilitate a bond between the plastic material and the laminate.

In this embodiment, a laminate (e.g., 10) can be positioned within composite body 178 such that the laminate is disposed within and/or on plate 146. More particularly, a length (e.g., 14) of the laminate can be aligned with length 158 of plate 146. To illustrate, if the laminate is laminate 10, fibers of 0-degree unidirectional laminae 34d-34f can be aligned with length 158 of plate 146, and fibers of 90-degree unidirectional laminae 34a-34c and 34g-34i can be aligned with width 162 of the plate. The length of the laminate disposed within and/or on plate 146 can be at least 50% (up to and including 100%) of length 158 of the plate (e.g., at least 50, 55, 60, 65, 70, 75, 80, 85, 90, or 95% of the length of the plate). A width (e.g., 18) of the laminate disposed within and/or on plate 146 can be at least 50% (up to and including 100%) of width 162 of the plate (e.g., at least 50, 55, 60, 65, 70, 75, 80, 85, 90, or 95% of the width of the plate). A thickness (e.g., 22) of the laminate disposed within and/or on plate 146 can be at least 50% (up to and including 100%) of a thickness 164 (FIG. 5B) of the plate (e.g., at least 50, 55, 60, 65, 70, 75, 80, 85, 90, or 95% of the width of the plate). Outer surface(s) of plate 146 can be defined by plastic material 182 and/or the laminate.

Some embodiments of the present methods comprise producing a laminate (e.g., 10) at least by stacking two or more laminae (e.g., including one or more of any lamina described above). During such stacking, any number of the laminae can be formed by placing sections (e.g., 98a-98d) of lamina material, such as, for example, sections of unidirectional fiber tape, adjacent to one another. Such stacking can be performed manually and/or using a laminate stacking machine. In some methods, the two or more laminae include two or more unidirectional first laminae (e.g., 34a-34c and 34g-34i) and one or more unidirectional second laminae (e.g., 34d-34f), and the stacking is performed such that: (1) fibers of the first laminae are aligned in a first direction; (2) fibers of the one or more second laminae are aligned in a second direction that is perpendicular to the first direction; and (3) the one or more second laminae are disposed in contact with one another and between two of the first laminae.

In some methods, the producing the laminate comprises applying heat and/or pressure to the stacked laminae (e.g., using a press). In some methods, the producing the laminate comprises trimming at least one of the laminae, which can be performed before, during, and/or after stacking the laminae and/or before and/or after applying heat and/or pressure to the stacked laminae.

In some methods, the producing the laminate is performed such that the laminate has: (1) a width (e.g., 18) that is aligned with the first direction; (2) a length (e.g., 14) that is aligned with the second direction, the length being between approximately 1.25 and approximately 1.80 times the width; (3) a thickness (e.g., 22) that is perpendicular to each of the width and the length, the thickness being between approximately 1.0 mm and approximately 1.5 mm; and (4) a first flexural rigidity along the width and a second flexural rigidity along the length, the second flexural rigidity being 10 to 30 times or 14 to 26 times the first flexural rigidity.

In some methods, the first flexural rigidity is determined using the following equation:

$${F}_{1} = {E}_{1} ( [ \frac{l \times {t}_{tot}^{3}}{12} ] - [ \frac{l \times {t}_{2}^{3}}{12} ] ) ,$$

where F₁ is the first flexural rigidity, E₁ is the modulus of elasticity of the first laminae along the width, l is the length, tₜₒₜ is the thickness of the laminate, and t₂ is the thickness of the one or more second laminae, and/or the second flexural rigidity is determined using the following equation:

$${F}_{2} = {E}_{2} [ \frac{w \times {t}_{2}^{3}}{12} ] ,$$

where F₂ is the second flexural rigidity, E₂ is the modulus of elasticity of the one or more second laminae along the length, and w is the width.

Some methods comprise producing a laptop A cover (e.g., 134) by overmolding a plastic material (e.g., 182) onto the laminate. For example, the laminate can be placed into a mold, and the plastic material can be injected into the mold, thereby overmolding the plastic material onto the laminate.

Some embodiments of the present laptop A covers comprise: a composite body defining a plate having a width and a length that is perpendicular to and larger than the width, wherein the composite body includes a plastic material and a laminate including two or more laminae, each having fibers dispersed within a matrix material, the laminate having a width, a length that is perpendicular to and larger than the width, and a first flexural rigidity along the width and a second flexural rigidity along the length, the second flexural rigidity being 10 to 30 times the first flexural rigidity, wherein the length of the laminate is at least 50% of the length of the plate, and wherein the laminate is disposed within and/or on the plate such that the length of the laminate is aligned with the length of the plate. In some A covers, the plate includes a planar portion and a lip that extends outwardly from and surrounds at least a majority of the planar portion.

In some A covers, the length of the laminate is between approximately 1.25 and approximately 1.80 times the width of the laminate, and/or the thickness of the laminate is between approximately 1.0 mm and approximately 1.5 mm. In some A covers, the length of the laminate is between approximately 25 cm and approximately 35 cm.

In some A covers, at least one of the laminae comprises a unidirectional lamina. In some A covers, the laminae include two or more unidirectional first laminae, each having fibers that are aligned with the width of the laminate, and one or more unidirectional second laminae disposed in contact with one another and between two of the first laminae, each having fibers that are aligned with the length of the laminate.

In some A covers, the first flexural rigidity is determined using the following equation:

$${F}_{1} = {E}_{1} ( [ \frac{l \times {t}_{tot}^{3}}{12} ] - [ \frac{l \times {t}_{2}^{3}}{12} ] ) ,$$

where F₁ is the first flexural rigidity, E₁ is the modulus of elasticity of the first laminae along the width of the laminate, l is the length of the laminate, tₜₒₜ is the thickness of the laminate, and t₂ is the thickness of the one or more second laminae, and/or the second flexural rigidity is determined using the following equation:

$${F}_{2} = {E}_{2} [ \frac{w \times {t}_{2}^{3}}{12} ] ,$$

where F₂ is the second flexural rigidity, E₂ is the modulus of elasticity of the one or more second laminae along the length of the laminate, and w is the width of the laminate.

Some embodiments of the present laminates comprise: two or more laminae, each having fibers dispersed within a matrix material, wherein the laminate has a width, a length that is perpendicular to the width, the length being between approximately 1.25 and approximately 1.80 times the width, a thickness that is perpendicular to each of the width and the length, the thickness being between approximately 1.0 mm and approximately 1.5 mm, and a first flexural rigidity along the width and a second flexural rigidity along the length, the second flexural rigidity being 10 to 30 times the first flexural rigidity. Some embodiments of the present laminates can be included in a portable electronic device housing.

In some laminates, the length is approximately 1.476 times the width, and the second flexural rigidity is 12 to 30 times the first flexural rigidity. In some laminates, the length is approximately 1.535 times the width, and the second flexural rigidity is 10 to 18 times the first flexural rigidity. In some laminates, the length is between approximately 25 cm and approximately 35 cm.

In some laminates, at least one of the laminae comprises a unidirectional lamina. Some laminates include two or more unidirectional first laminae, each having fibers that are aligned with the width of the laminate, and one or more unidirectional second laminae disposed in contact with one another and between two of the first laminae, each having fibers that are aligned with the length of the laminate. In some laminates, at least one of the laminae has a fiber volume fraction of approximately 60%.

In some laminates, the first flexural rigidity is determined using the following equation:

$${F}_{1} = {E}_{1} ( [ \frac{l \times {t}_{tot}^{3}}{12} ] - [ \frac{l \times {t}_{2}^{3}}{12} ] ) ,$$

where F₁ is the first flexural rigidity, E₁ is the modulus of elasticity of the first laminae along the width, l is the length, tₜₒₜ is the thickness of the laminate, and t₂ is the thickness of the one or more second laminae, and/or the second flexural rigidity is determined using the following equation:

$${F}_{2} = {E}_{2} [ \frac{w \times {t}_{2}^{3}}{12} ] ,$$

where F₂ is the second flexural rigidity, E₂ is the modulus of elasticity of the one or more second laminae along the length, and w is the width.

Some embodiments of the present methods comprise: producing a laminate at least by stacking two or more unidirectional first laminae and one or more unidirectional second laminae such that fibers of the first laminae are aligned in a first direction, fibers of the one or more second laminae are aligned in a second direction that is perpendicular to the first direction, and the one or more second laminae are disposed in contact with one another and between two of the first laminae, wherein the producing the laminate is performed such that the laminate has a width that is aligned with the first direction, a length that is aligned with the second direction, the length being between approximately 1.25 and approximately 1.80 times the width, a thickness that is perpendicular to each of the width and the length, the thickness being between approximately 1.0 mm and approximately 1.5 mm, and a first flexural rigidity along the width and a second flexural rigidity along the length, the second flexural rigidity being 10 to 30 times the first flexural rigidity. In some methods, the producing the laminate comprises applying heat and/or pressure to the stacked laminae, and, optionally, trimming at least one of the laminae. Some methods comprise producing a laptop A cover by overmolding a plastic material onto the laminate.

In some methods, the first flexural rigidity is determined using the following equation:

$${F}_{1} = {E}_{1} ( [ \frac{l \times {t}_{tot}^{3}}{12} ] - [ \frac{l \times {t}_{2}^{3}}{12} ] ) ,$$

where F₁ is the first flexural rigidity, E₁ is the modulus of elasticity of the first laminae along the width, l is the length, tₜₒₜ is the thickness of the laminate, and t₂ is the thickness of the one or more second laminae, and/or the second flexural rigidity is determined using the following equation:

$${F}_{2} = {E}_{2} [ \frac{w \times {t}_{2}^{3}}{12} ] ,$$

where F₂ is the second flexural rigidity, E₂ is the modulus of elasticity of the one or more second laminae along the length, and w is the width.

### EXAMPLES

The present invention will be described in greater detail by way of specific examples. The following examples are offered for illustrative purposes only and are not intended to limit the invention in any manner. Those of skill in the art will readily recognize a variety of noncritical parameters that can be changed or modified to yield essentially the same results.

### Example 1

### Deflection Testing of Laminates

Referring now to FIG. 6, a deflection of a laminate (e.g., 10) can be determined by simply supporting edges 194 of the laminate and applying a load 196 perpendicularly to and at a center 198 of the laminate. In some instances, when load 196 is 100 N, center 198 of the laminate may deflect by no more than 4.0, 3.9, 3.8, 3.7, 3.6, or 3.5 mm.

### Example 2

### Exemplary Laminates of the Present Disclosure

Exemplary laminates can be prepared using combinations of the unidirectional laminae in TABLE 1. Each of the laminae in TABLE 1 includes carbon fibers having a modulus of elasticity of 250-255 gigapascals GPa and a matrix material including polycarbonate.

TABLE 1
Laminae for Producing Laminates of the Present Disclosure

| | Lamina 1 | Lamina 2 | Lamina 3 |
|---|---|---|---|
| Thickness (mm) | 0.1389 | 0.13 | 0.1567 |
| Fiber Volume | 60% | 60% | 60% |
| Fraction (%) | | | |

Some such exemplary laminates are provided in TABLE 2.

TABLE 2
Exemplary Laminates of the Present Disclosure

| | Laminate 1 | Laminate 2 |
|---|---|---|
| Layup | 3 plies of Lamina 1 at 90 | 3 plies of Lamina 2 at 90 |
| | degrees/3 plies of Lamina | degrees/3 plies of Lamina 3 |
| | 1 at 0 degrees/3 plies of | at 0 degrees/3 plies of |
| | Lamina 1 at 90 degrees | Lamina 2 at 90 degrees |
| Length (mm) | 310 | 310 |
| Width (mm) | 210 | 210 |
| Thickness | 1.25 | 1.25 |
| (mm) | | |

### Example 3

### Exemplary Laminates of the Present Disclosure

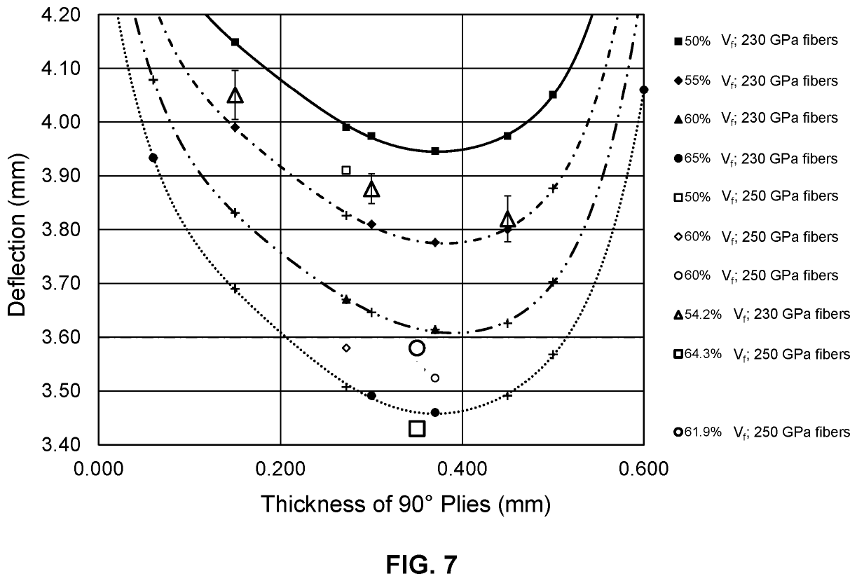

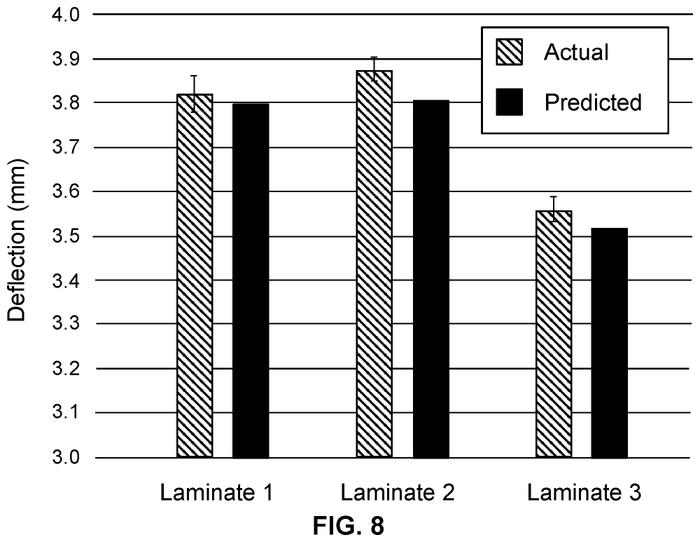

FIG. 7 is a graph showing deflection vs. thickness of 90-degree plies for laminates of the present disclosure. Each of the laminates has the following lay-up: one or more 90-degree plies/one or more 0-degree plies/one or more 90-degree plies. For each of the laminates, the total thickness is 1.2 mm, and the collective thickness of the 90-degree plies is shown on the x-axis. The indicated deflection for each of the laminates was determined using the procedure outlined in Example 1 at a load 196 of 100 N. For ones of the laminates represented by smaller markers, the deflections were determined using a simulation, and, for ones of the laminates represented by larger markers (the last three in the legend), the deflections were determined by producing and physically testing the laminates.

### Example 4

### Exemplary Laminates of the Present Disclosure

Three exemplary laminates were prepared, properties of which are provided in TABLE 3.

TABLE 3
Exemplary Laminates of the Present Disclosure

| | Laminate 1 | Laminate 2 | Laminate 3 |
|---|---|---|---|
| Layup | 1 90-degree | 2 90-degree | 3 90-degree |
| | ply/7 0-degree | plies/5 0-degree | plies/3 0-degree |
| | plies/1 90 | plies/2 90 | plies/3 90 |
| | degree ply | degree plies | degree plies |
| Fiber Volume | 54.2% | 54.2% | 61% |
| Fraction | | | |
| Modulus of | 230 | 230 | 250 |
| Elasticity of | | | |
| Fibers (GPa) | | | |

FIG. 8 is a graph showing actual and predicted deflections for Laminates 1-3. For each of the laminates, the indicated deflections were determined using the procedure outlined in Example 1 at a load 196 of 100 N. The predicted deflections were determined using a simulation and the actual deflections were determined by physical testing.

The above specification and examples provide a complete description of the structure and use of illustrative embodiments. Although certain embodiments have been described above with a certain degree of particularity, or with reference to one or more individual embodiments, those skilled in the art could make numerous alterations to the disclosed embodiments without departing from the scope of this invention. As such, the various illustrative embodiments of the methods and systems are not intended to be limited to the particular forms disclosed. Rather, they include all modifications and alternatives falling within the scope of the claims, and embodiments other than the one shown may include some or all of the features of the depicted embodiment. For example, elements may be omitted or combined as a unitary structure, and/or connections may be substituted. Further, where appropriate, aspects of any of the examples described above may be combined with aspects of any of the other examples described to form further examples having comparable or different properties and/or functions, and addressing the same or different problems. Similarly, it will be understood that the benefits and advantages described above may relate to one embodiment or may relate to several embodiments.

The claims are not intended to include, and should not be interpreted to include, means-plus- or step-plus-function limitations, unless such a limitation is explicitly recited in a given claim using the phrase(s) “means for” or “step for,” respectively.

1. A laptop A cover comprising:
a composite body defining a plate having a width and a length that is perpendicular to and larger than the width;
wherein the composite body includes:
a plastic material; and
a laminate including two or more laminae, each having fibers dispersed within a matrix material, the laminate having:
a width;
a length that is perpendicular to and larger than the width; and
a first flexural rigidity along the width and a second flexural rigidity along the length, the second flexural rigidity being 10 to 30 times the first flexural rigidity;
wherein the length of the laminate is at least 50% of the length of the plate; and
wherein the laminate is disposed within and/or on the plate such that the length of the laminate is aligned with the length of the plate.

2. The laptop A cover of claim 1, wherein the plate includes a planar portion and a lip that extends outwardly from and surrounds at least a majority of the planar portion.

3. The laptop A cover of claim 1, wherein:
the length of the laminate is between approximately 1.25 and approximately 1.80 times the width of the laminate; and/or
the thickness of the laminate is between approximately 1.0 millimeter (mm) and approximately 1.5 mm.

4. The laptop A cover of claim 3, wherein the length of the laminate is between approximately 25 centimeters (cm) and approximately 35 cm.

5. The laptop A cover of any of claims 1-4, wherein at least one of the laminae comprises a unidirectional lamina.

6. The laptop A cover of any of claims 1-4, wherein the laminae include:
two or more unidirectional first laminae, each having fibers that are aligned with the width of the laminate; and
one or more unidirectional second laminae disposed in contact with one another and between two of the first laminae, each having fibers that are aligned with the length of the laminate.

7. The laptop A cover of claim 6, wherein:
the first flexural rigidity is determined using the following equation:
$${F}_{1} = {E}_{1} ( [ \frac{l \times {t}_{tot}^{3}}{12} ] - [ \frac{l \times {t}_{2}^{3}}{12} ] ) ,$$
where F₁ is the first flexural rigidity, E₁ is the modulus of elasticity of the first laminae along the width of the laminate, l is the length of the laminate, tₜₒₜ is the thickness of the laminate, and t₂ is the thickness of the one or more second laminae; and/or
the second flexural rigidity is determined using the following equation:
$${F}_{2} = {E}_{2} [ \frac{w \times {t}_{2}^{3}}{12} ] ,$$
where F₂ is the second flexural rigidity, E₂ is the modulus of elasticity of the one or more second laminae along the length of the laminate, and w is the width of the laminate.

8. A laminate comprising:
two or more laminae, each having fibers dispersed within a matrix material;
wherein the laminate has:
a width;
a length that is perpendicular to the width, the length being between approximately 1.25 and approximately 1.80 times the width;
a thickness that is perpendicular to each of the width and the length, the thickness being between approximately 1.0 mm and approximately 1.5 mm; and
a first flexural rigidity along the width and a second flexural rigidity along the length, the second flexural rigidity being 10 to 30 times the first flexural rigidity.

9. The laminate of claim 8, wherein:
the length is approximately 1.476 times the width; and
the second flexural rigidity is 12 to 30 times the first flexural rigidity.

10. The laminate of claim 8, wherein:
the length is approximately 1.535 times the width; and
the second flexural rigidity is 10 to 18 times the first flexural rigidity.

11. The laminate of any of claims 8-10, wherein the length is between approximately 25 cm and approximately 35 cm.

12. The laminate of any of claims 8-10, wherein at least one of the laminae comprises a unidirectional lamina.

13. The laminate of any of claims 8-10, wherein at least one of the laminae has a fiber volume fraction of approximately 60%.

14. The laminate of any of claims 8-10, wherein the laminae include:
two or more unidirectional first laminae, each having fibers that are aligned with the width of the laminate; and
one or more unidirectional second laminae disposed in contact with one another and between two of the first laminae, each having fibers that are aligned with the length of the laminate.

15. The laminate of claim 14, wherein
the first flexural rigidity is determined using the following equation:
$${F}_{1} = {E}_{1} ( [ \frac{l \times {t}_{tot}^{3}}{12} ] - [ \frac{l \times {t}_{2}^{3}}{12} ] ) ,$$
where F₁ is the first flexural rigidity, E₁ is the modulus of elasticity of the first laminae along the width, l is the length, tₜₒₜ is the thickness of the laminate, and t₂ is the thickness of the one or more second laminae; and/or
the second flexural rigidity is determined using the following equation:
$${F}_{2} = {E}_{2} [ \frac{w \times {t}_{2}^{3}}{12} ] ,$$
where F₂ is the second flexural rigidity, E₂ is the modulus of elasticity of the one or more second laminae along the length, and w is the width.

16. A portable electronic device housing comprising the laminate of any of claims 8-10.

17. A method comprising:
producing a laminate at least by stacking two or more unidirectional first laminae and one or more unidirectional second laminae such that:
fibers of the first laminae are aligned in a first direction;
fibers of the one or more second laminae are aligned in a second direction that is perpendicular to the first direction; and
the one or more second laminae are disposed in contact with one another and between two of the first laminae;
wherein the producing the laminate is performed such that the laminate has:
a width that is aligned with the first direction;
a length that is aligned with the second direction, the length being between approximately 1.25 and approximately 1.80 times the width;
a thickness that is perpendicular to each of the width and the length, the thickness being between approximately 1.0 mm and approximately 1.5 mm; and
a first flexural rigidity along the width and a second flexural rigidity along the length, the second flexural rigidity being 10 to 30 times the first flexural rigidity.

18. The method of claim 17, wherein the producing the laminate comprises:
applying heat and/or pressure to the stacked laminae; and
optionally, trimming at least one of the laminae.

19. The method of claim 17, wherein:
the first flexural rigidity is determined using the following equation:
$${F}_{1} = {E}_{1} ( [ \frac{l \times {t}_{tot}^{3}}{12} ] - [ \frac{l \times {t}_{2}^{3}}{12} ] ) ,$$
where F₁ is the first flexural rigidity, E₁ is the modulus of elasticity of the first laminae along the width, l is the length, tₜₒₜ is the thickness of the laminate, and t₂ is the thickness of the one or more second laminae; and/or
the second flexural rigidity is determined using the following equation:
$${F}_{2} = {E}_{2} [ \frac{w \times {t}_{2}^{3}}{12} ] ,$$
where F₂ is the second flexural rigidity, E₂ is the modulus of elasticity of the one or more second laminae along the length, and w is the width.

20. The method of claim 19, comprising producing a laptop A cover by overmolding a plastic material onto the laminate.
